(19) United States
(12) Patent Application Publication
(10) Pub. No.: US 2007/0139172 A1
(43) Pub. Date: Jun. 21, 2007

(54) REMOTE CONTROL DEVICE

(76) Inventors: Junichiro Watanabe, London (GB); Takeshi Hoshino, Kodaira (JP); Youichi Horii, Mitaka (JP); Sergio Paolantonio, Kokubunji (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/560,020

(22) Filed: Nov. 15, 2006

(30) Foreign Application Priority Data
Nov. 16, 2005 (JP) 2005-331019

(51) Int. Cl. B60R 25/10; G08C 19/12

(52) U.S. Cl. 340/426.13; 341/176

(57) ABSTRACT

A remote control device is provided which has a plurality of LEDs arranged on different surfaces of its body and a means for transmitting different signals from the different LEDs corresponding to direction buttons. The signal receiving unit of a target device to be operated, such as a television, receives a signal from only one LED as a valid signal according to the direction in which the remote control device is held. Different direction signals corresponding to “up”, “down”, “left” and “right” are received according to the direction in which the remote control device is held. Thus the remote control device can move the cursor on GUI up, down, left or right, without requiring the operator to consider the direction in which the remote control device is held.

### INCORPORATION BY REFERENCE

The present application claims priority from Japanese application JP2005-331019 filed on Nov. 16, 2005, the content of which is hereby incorporated by reference into this application.

### BACKGROUND OF THE INVENTION

The present invention relates to a remote control device.

Television sets with a large-size display have come into widespread use in recent years. Such a large-size television is placed in a living room or dining room and has become an optimal information display device for family members to watch TV programs and movies. Like the large-size televisions, recorders with a large-capacity hard disk drive (hereinafter referred to as HDD) are also in wide use. With these devices, it has now become possible to record television programs for long hours. Not only television programs but image files shot by digital cameras, video files recorded by digital video cameras and music files can also be stored, and these media files can be displayed on the large-size TV. Further, personal computers (PC) have come to incorporate a television tuner and therefore can display and record television programs. If there are two or more PCs in home, they can be connected by a wired or wireless network so that the media files can be transferred or shared among the PCs and viewed in any PC.

Standards are being prepared and made public for data transmission among electric appliances including televisions, PCs and mobile devices such as cell phones, and software and hardware conforming to such standards are becoming available. These allow devices of different manufacturers to be connected easily.

With various devices in the home networked, it is possible to view or listen to content such as videos, still images and music stored in HDDs of other devices from any desired device in the home. This is convenient. That is, one can make a connection not only between a PC and a PC but also between a PC and a television or between a PC and a HDD recorder and view on a large-size television in a living room a TV program or video file stored in the PC placed in another room.

However, if various devices are networked, the number of devices to be operated by the user also increases. Each device requires a dedicated remote controller. The shapes and specifications of these remote controllers differ among different devices and manufacturers. Further, different devices have different graphical user interfaces (GUIs) for remote controllers. Therefore, the user is required to use multiple remote controllers for the devices he or she wishes to operate. Different remotes and GUIs have different operation feels and thus using these remotes is very cumbersome. Since there are as many dedicated remotes as there are devices to be operated, they may be scattered around in the home and lost, which is not desirable for the user.

One of conceivable methods to solve this problem is to operate two or more devices with a single remote. This uses an inclination detection sensor to determine a direction of the remote and operates different devices according to the detected direction.

This method, however, has a drawback. Consider a case where the user wishes to move a cursor up, down, left and right on a screen. If the direction in which the remote is held changes, the vertical direction of the remote no longer matches the vertical direction on the screen. So, the operator must be conscious of the direction of the remote at all times when operating on the screen. For example, when the remote is turned 90 degrees to the right for operation, the “up” key among the direction keys on the remote points to the right for the operator, the “right” key points “down” for the operator, the “down” key points to the left for the operator, and the “left” key points “up” for the operator. So, the directions on the screen do not match those on the remote. If the operator wants to move a cursor up, he is required to press the “up” key that points to the right. That is, when the direction in which the remote is held is changed and if the cursor on the GUI of the target device is to be moved up, down, left and right, the operator needs to be conscious of the direction of the remote and figure out which key match the intended direction on the screen.

### SUMMARY OF THE INVENTION

The present invention is accomplished to solve the above-described problem and it is an object of this invention to provide a method for operating a plurality of GUIs with the same remote controller. More specifically, a method is provided which can operate different devices by changing the direction in which the remote control device is held with respect to the target device. It is also an object of this invention to provide a method which allows an operator to perform basic operations, such as “up”, “down”, “left” and “right” movement of a cursor, independently of GUI, without having to be conscious of the direction of the remote control device even when the direction in which the remote control device is held is changed.

To achieve the above objective, this invention provides a remote control device which comprises a plurality of LEDs mounted on a body of the remote control device and a means for simultaneously transmitting different signals from these LEDs when a direction button is operated. A signal receiving unit of a target device to be operated, such as a television, receives a signal from only one of the LEDs as a valid signal. If the LEDs are matched to different directions of the remote control device, the television receives a different signal according to the direction in which the remote control device is held. That is, if the same direction button, one of “up”, “down”, “left” and “right” direction buttons, is pressed, a different signal is transmitted depending on how the remote control device is held. This allows for the cursor movement on the GUI without having to consider the direction in which the remote control device is held.

Further, this invention is characterized by an LED provided to the back of the remote control device. If the operator holds the remote control device vertically inclined with respect to the receiving unit of the television, the LED on the back squarely faces the television, allowing for GUI operations.

Further, this invention is characterized by a means, such as a tilt sensor, provided in the remote control device to detect an inclination. When the remote control device is held vertical with respect to a television screen, this means can determine which side of the remote control device faces up. This in turn makes it possible to dynamically change the signal transmitted from the LED at the back of the remote control device according to an input value from the tilt sensor. Therefore, if the remote control device is held vertical with respect to the television, it transmits a different signal according to whether the device is held lengthwise or sideways, allowing for “up”, “down”, “left” or “right” cursor movement on GUI without having to consider the direction in which the remote control device is held.

Further, this invention is characterized by a beacon receiver provided on the remote control device. Two or more of the beacon receivers are mounted on the remote control device, for example, by the side of an LED arranged on each side of the remote control device. With this arrangement, it is possible to transmit a signal from only the LED close to the beacon receiver that has first received the beacon from the television and not to produce a signal from other LEDs. Therefore, the direction in which the remote control device is held can be matched to a signal with high precision even when the remote control device is held at an angle with respect to the television.

With this invention, different target devices can be operated with a single remote control device by holding it in proper directions.

Further, the “up”, “down”, “left” and “right” directions on the remote control device can be matched to the “up”, “down”, “left” and “right” directions on the GUI, without requiring the operator to be conscious of the direction in which the remote control device is held.

Further, not only when the remote control device is held horizontal with respect to the target device to be operated but also when it is held vertical with respect to the television, different signals can be transmitted from the remote control device when it is held in different directions.

Further, by installing a beacon transmitter on the target device to be operated, such as television, and beacon receivers on the remote control device, it is possible to precisely determine the direction in which the remote control device is held and to transmit the corresponding signal.

This invention provides a method of improving an operability when a plurality of networked devices are operated with one and the same remote control device.

Other objects, features and advantages of the invention will become apparent from the following description of the embodiments of the invention taken in conjunction with the accompanying drawings.

### BRIEF DESCRIPTION OF THE DRAWINGS

FIGS. 1A and 1B are schematic diagrams showing an example of a remote controller of this invention.

FIGS. 2A to 2D are schematic diagrams showing how the remote controller is operated when it is held horizontally, according to this invention

FIGS. 3A and 3B illustrate outline configurations of a television and a remote controller according to this invention.

FIGS. 4A and 4B illustrate an outline of a remote controller body according to this invention.

FIGS. 5A to 5C illustrate an example of the remote controller when it is held vertically, according to this invention.

FIG. 6 illustrates a flow of processing performed by the remote controller when it is held vertically, according to this invention.

FIG. 7 illustrates an example of the remote controller when it is held diagonally, according to this invention.

FIG. 8 illustrates a flow of processing performed by a television when the remote controller is held diagonally, according to this invention.

FIG. 9 illustrates a flow of processing performed by the remote controller when it is held diagonally, according to this invention.

### DESCRIPTION OF THE EMBODIMENTS

Now, embodiments of this invention will be described by referring to the accompanying drawings. Here, although a television is taken up as an example of the device to be operated, other devices may be used as long as they use a remote controller as an input device and takes directions, such as “up”, “down”, “left” and “right”, as input information. Here, we will describe an example case in which a cursor is moved up, down, left and right on a GUI displayed on a TV screen by a remote controller or a remote.

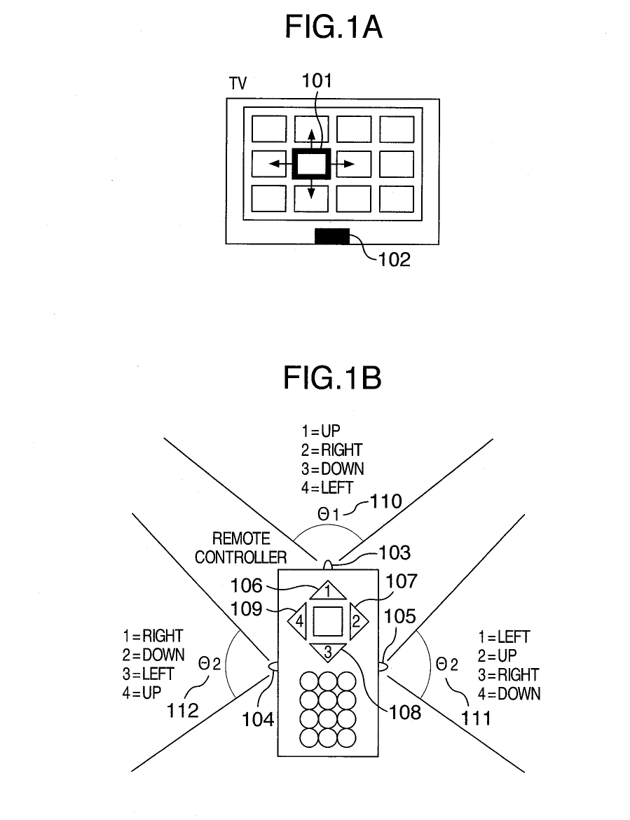

FIGS. 1A and 1B show an example of a remote and a GUI operated by the remote, according to this invention. FIG. 1A illustrates a television, in which a reference number 101 represents a cursor and 102 a receiver to receive a signal from the remote.

FIG. 1B shows a remote. In the figure, reference numbers 103, 104 and 105 represent signal transmitters such as LEDs; 106 represents a button 1, 107 a button 2, 108 a button 3 and 109 a button 4, all direction input buttons for inputting directions, “up”, “down”, “left” or “right”; and 11001 represents an angle (beam width) of a signal transmitted from the LED 103, and 111θ2 and 112θ2 represent angles (beam widths) of signals transmitted from the LED104 or LED105.

In the example of FIG. 1B, these LEDs are arranged on three sides, upper, left and right sides, of the remote.

In the figure, depressing the up, down, left and right buttons on the remote causes all the LEDs to simultaneously transmit signals which are different from one another. For example, the LED 103 on the upper side of the remote transmits a signal representing “up” when the button 1 is pressed, a signal representing “right” when the button 2 is pressed, a signal representing “down” when the button 3 is pressed, and a signal representing “left” when the button 4 is pressed. The LED 104 on the left side of the remote transmits a signal representing “right” when the button 1 is pressed, a signal representing “down” when the button 2 is pressed, a signal representing “left” when the button 3 is pressed, and a signal representing “up” when the button 4 is pressed.

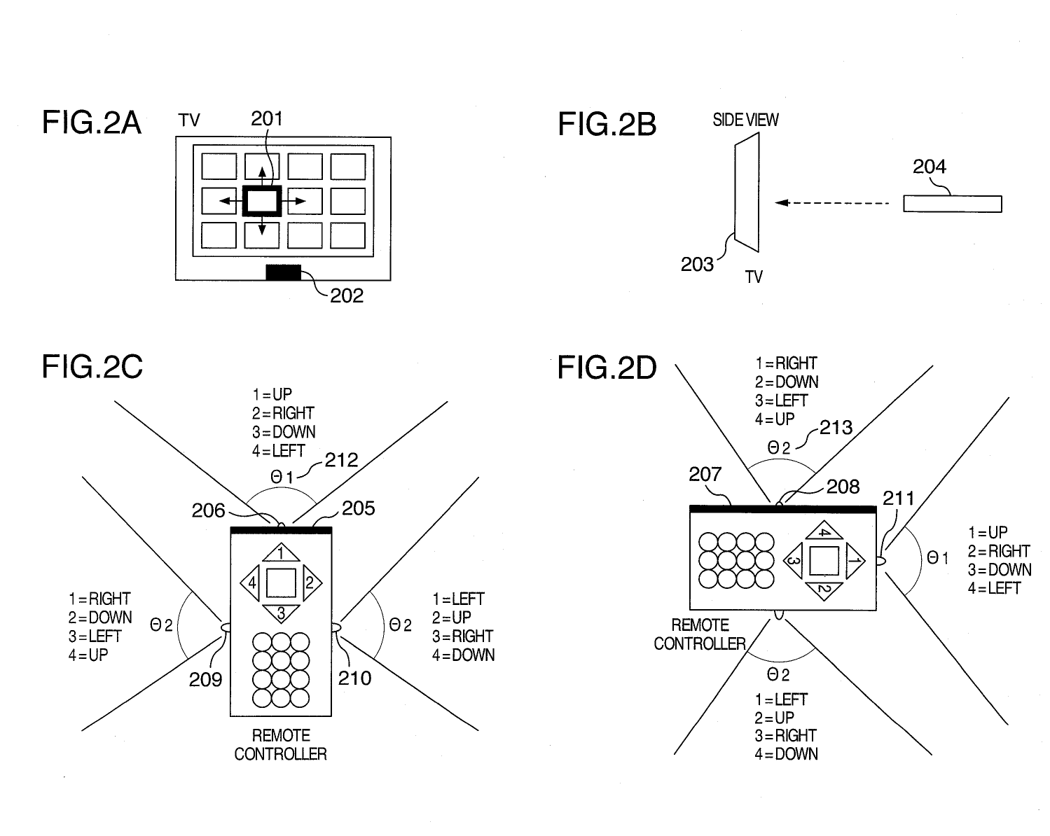

FIGS. 2A-2D show an example of how the remote is used according to this invention. FIG. 2A represent the same television and GUI that are shown in FIG. 1A. Denoted 201 is a cursor and 202 a receiver to receive a signal from the remote.

As shown in FIG. 2B, the remote in this example is held horizontal. Reference number 203 is the television as seen from its side and 204 the remote as seen from its side.

FIG. 2C shows the upper side 205 of the remote to perpendicularly face the television screen. In this case, as explained in FIG. 1B, all LEDs emits signals simultaneously but the only signal that the receiver of the television receives is one from the LED 206 at the upper side 205 of the remote (signals of other LEDs do not reach the receiver of the television because of the relation between the direction of the remote and the beam width of each LED). The receiver receives a signal representing “up” when the button 1 is pressed, a signal representing “right” when the button 2 is pressed, a signal representing “down” when the button 3 is pressed, and a signal representing “left” when the button 4 is pressed, thus moving the cursor on the GUI in the same direction as the button operation on the remote.

FIG. 2D shows the left side 207 of the remote to perpendicularly face the television screen. In this case, the only signal that the television receives is one from the LED 208 at the left side 207 of the remote. The receiver receives a signal representing “right” when the button 1 is pressed, a signal representing “down” when the button 2 is pressed, a signal representing “left” when the button 3 is pressed, and a signal representing “up” when the button 4 is pressed.

As explained in FIGS. 2A-2D, since the signal the television receives changes according to the direction of the remote, the direction of the button on the remote which the operator thinks is “up” and which he presses can be made to match the “up” direction on the television screen as seen by the operator, regardless of how the remote is held. Suppose the remote has only one transmitter. When the upper side of the remote is set to perpendicularly face the television, the “up” direction on the television screen matches the “up” direction on the remote. However, when the left side of the remote is set to perpendicularly oppose the television, the “up” direction on the remote matches the “left” direction on the television screen. That is, the vertical and horizontal direction operations on the remote do not match the cursor movement direction on the television screen.

With the method of this invention explained in FIGS. 2A-2D, the vertical and horizontal direction operations on the remote can be made to match the vertical and horizontal cursor movement on the television screen.

If the remote is held sideways as shown in FIG. 2D, the operator may hold it with both hands. In that case, the LED 211 is covered by hand. This is equivalent to a state where the signal from the LED 211 is not emitted. If the remote is held longitudinally as shown in FIG. 2C, the LED 209 or LED 210 is mostly not covered with hand, allowing signals to be transmitted from all LEDs.

Considering these, it is preferred that the angle (beam width) of signal transmission 213θ2 be set narrower than 212θ1 so that, when the remote is held as shown in FIG. 2C, the signals from the LED 209 or LED 210 will not reach the television. When the remote is held as shown in FIG. 2D, the signal of the LED 211 is blocked by hand, so that the signal transmission angle (beam width) θ1 may be large.

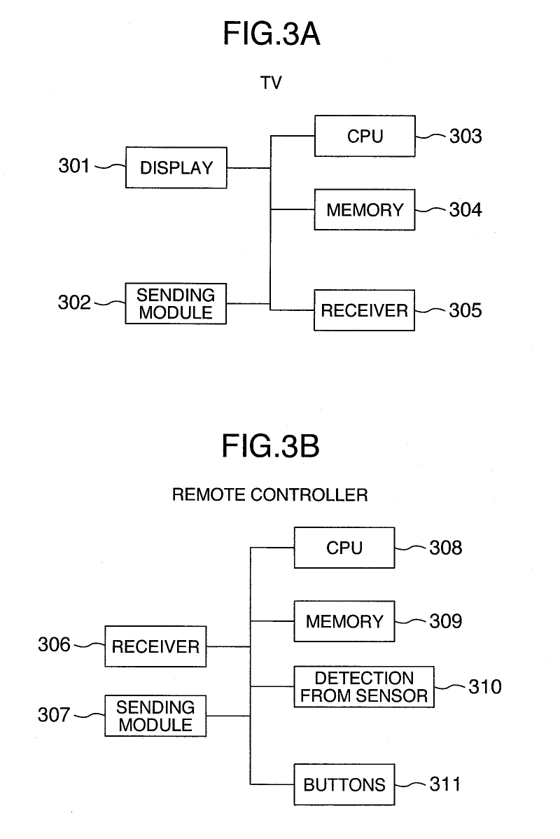

FIGS. 3A and 3B show outline configurations of the television and the remote according to this invention. FIG. 3A shows the configuration of the television, in which reference number 301 represents a display, 302 a beacon signal sending module, 303 a CPU, 304 a memory and 305 a receiver to receive a signal from the remote. The CPU 303 analyzes the signal from the remote received by the receiver 305 and determines direction information to be used in the TV operation control.

FIG. 3B shows the configuration of the remote. Denoted 306 is a beacon signal receiver, 307 a sending module (equivalent to LED 103-105), 308 a CPU, 309 a memory, 310 a detector of a signal from a tilt sensor, and 311 buttons, such as up, down, left and right key (corresponding to buttons 106-109). The CPU 308, based on the direction information entered from the button, generates a signal to be transmitted from the associated sending module.

As explained in FIG. 2C and FIG. 2D, the sending module 307 of the remote is arranged on each side of the remote. That is, a single remote has two or more of the sending modules. These sending modules transmits different signals simultaneously when these buttons on the remote are operated.

The television has one receiver 305. As explained in FIG. 2C and FIG. 2D, the receiver receives one of the different signals transmitted from the plurality of the sending modules of the remote.

The signals transmitted from the sending modules may include information representing directions already transformed as explained in FIG. 2C and FIG. 2D. Alternatively, the direction information itself may not be transformed but may be attached with sending module ID information that identifies the sending module that has transmitted the direction information. In that case, the CPU 303 on the television side may perform the transformation of the direction information received together with the sending module ID information.

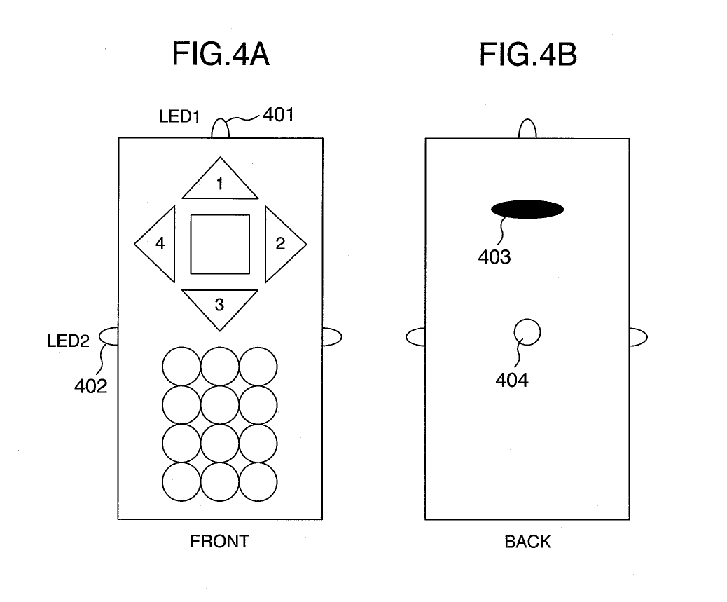

FIGS. 4A and 4B shows external views of a body of the remote. Denoted 401 and 402 are LEDs, 403 a tilt sensor to detect the tilt of the remote, and 404 an LED. The LED 404 is arranged on the back of the remote. In the following description, 401 is called LED1 and 402 LED2. The side where the LED1 is arranged is called an “upper side of the remote” and the side where the LED2 is arranged is called a “left side of the remote”.

We have explained about the method that allows the operator to move the cursor up, down, left or right on GUI without having to be conscious of the direction in which the remote is held (i.e., whether the remote is disposed lengthwise or sideways). However, the remote is not always held horizontally and often held tilted at an angle (beam width) close to a vertical direction. In such a case, the directions in which the signals are transmitted from the LEDs on the sides of the remote are not toward the television, so the signals are not received by the receiver of the television.

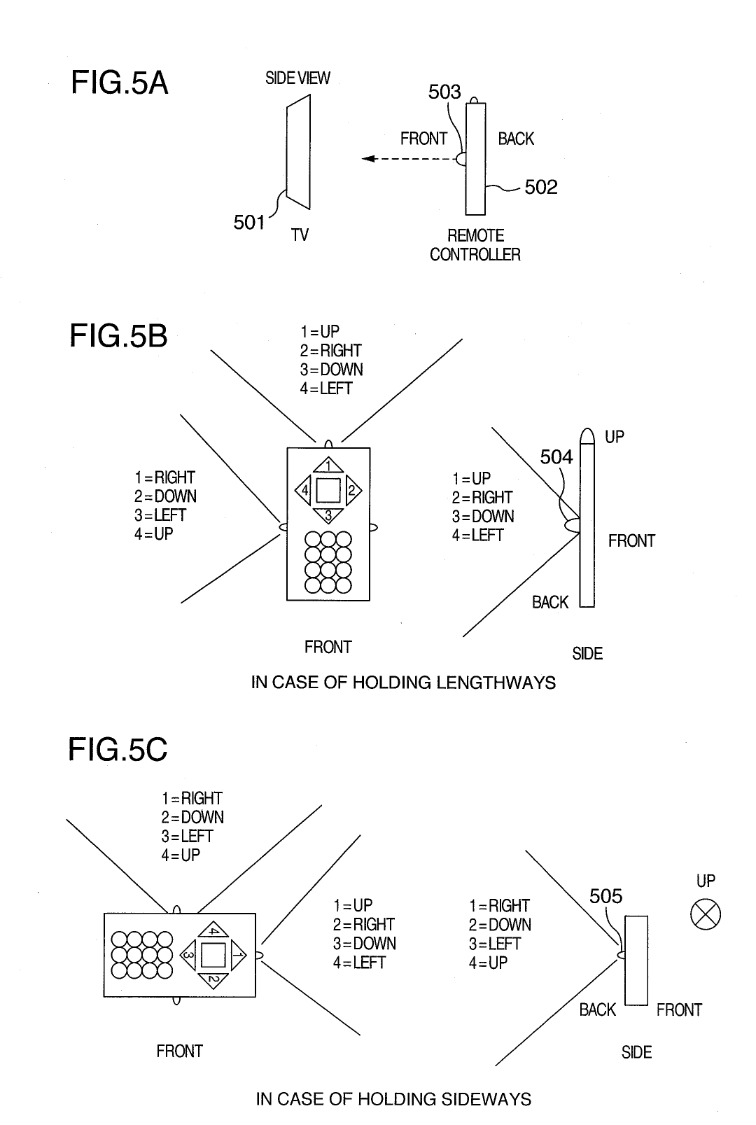

FIGS. 5A-5C shows a method for solving such a problem. FIG. 5A shows a case where the remote is held (almost) vertical with respect to the television. This is equivalent to a situation where the user is watching the television as he or she sits resting against the back of a chair and may find it difficult to hold the remote horizontally with respect to the television.

FIG. 5A is a side view of the television 501 and the remote 502, with the remote hold (almost) vertical and with the LED 503 arranged at the back of the remote.

As explained in connection with FIG. 4A and FIG. 4B, by arranging the LED 404 also at the back of the remote, the direction of a signal emitted from the LED of the remote is parallel to the direction from the remote toward the receiver of the television. So, the receiver of the television can receive the signal from the remote even if the remote is held vertical.

Now, we will explain about a method which, when the remote is held vertical, allows the operator to move a cursor on the television up, down, left and right with the same normal operation procedure without having to be conscious of the direction of the remote, i.e., whether the remote is held lengthwise or sideways.

Which part of the remote points “up” can be determined by the tilt sensor in the remote. The signal transmitted from the LED at the back is switched between a signal representing “up” and a signal representing “right” even when the same button 1 (106) is pressed, depending on whether the upper side or the left side of the remote is found to be situated at the top of the remote. This arrangement enables the remote to transmit two different signals, one transmitted when the remote is held longitudinal and one transmitted when the remote is held sideways, allowing the operator to move the GUI cursor up, down, left and right on the television screen without having to be conscious of the direction of the remote even if the remote is held vertical.

FIG. 5B shows a case where the remote is held vertically and lenthways. In the figure, from a signal from the tilt sensor of the remote, the upper side of the remote is found to face upward. As a result, the LED 504 at the back of the remote transmits a signal representing “up” when the “up” key on the remote is pressed, a signal representing “right” when the “right” key is pressed, a signal representing “down” when the “down” key is pressed, and a signal representing “left” when the “left” key is pressed.

FIG. 5C shows a case where the remote is held vertically and sideways. In FIG. 5C, from a signal from the tilt sensor of the remote, the left side of the remote is found to face upward. As a result, the LED 505 at the back of the remote transmits a signal representing “right” when the “up” key on the remote is pressed, a signal representing “down” when the “right” key is pressed, a signal representing “left” when the “down” key is pressed, and a signal representing “up” when the “left” key is pressed.

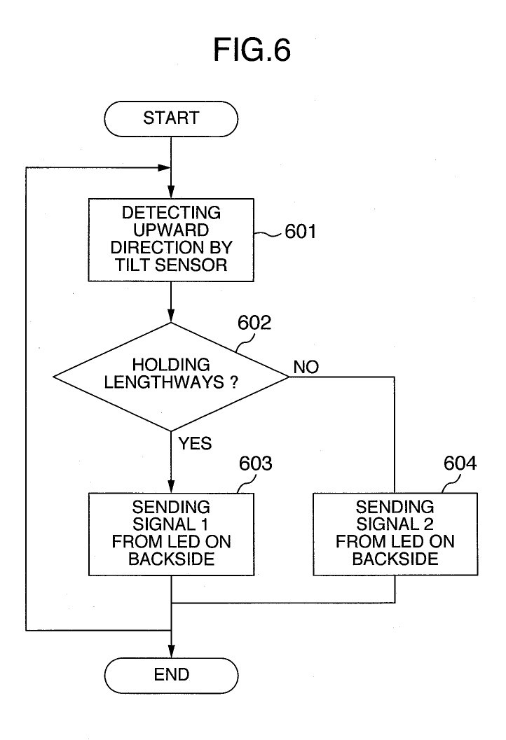

FIG. 6 shows a flow of processing performed by the remote when the remote is held vertical.

First, the sensor such as a tilt sensor in the remote to detect an inclination sends a signal representing how much the body of the remote tilts against the ground surface to the CPU of the remote which then calculates the “up” direction of the remote at a step 601. As a result, which side of the remote faces “up” can be determined. In this example, a step 602 that checks which of the upper side and the left side of the remote faces up may instead check whether the right side or the lower side of the remote faces up.

If the decision finds that the upper side of the remote faces up, the LED at the back of the remote transmits a signal 1 (step 603). The signal 1 transmitted represents “up” when the button 1 is pressed, “right” when the button 2 is pressed, “down” when the button 3 is pressed, and “left” when the button 4 is pressed.

If the decision finds that the left side of the remote faces up, the LED at the back of the remote transmits a signal 2 (step 604). The signal 2 transmitted represents “right” when the button 1 is pressed, “down” when the button 2 is pressed, “left” when the button 3 is pressed, and “up” when the button 4 is pressed.

In the two cases where the remote is held horizontal and where it is held vertical, the method has been explained which allows the GUI cursor on the television screen to be moved up, down, left and right with the same normal operation procedure regardless of whether the remote is held lengthwise or sideways.

Where the remote is held horizontal, not only may each side of the remote be held to perpendicularly face the television, it may also be held at an angle with respect to the television. In such a case, with the method described so far, which side of the remote squarely faces the television cannot be determined precisely, giving rise to a possibility of a signal different from the desired one being transmitted.

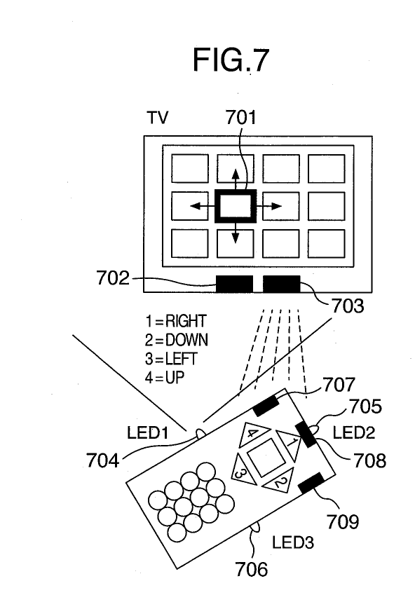

FIG. 7 shows a means to solve the above problem. In the figure, the television displays a GUI and a cursor 701. The television has a receiver 702 to receive a signal from the remote and a transmitter 703 to transmit a periodical signal such as a beacon. The beacon signal is emitted at all times. The remote has at its sides signal transmitting LEDs 704, 705, 706 and receivers 707, 708, 709 to receive the beacon signal from the television.

If the remote is held at an angle with respect to the television, a side of the remote where its associated receiver has first received the beacon signal from the television is determined to face the television. The signal transmission from other LEDs than the one attached to that side is stopped so that the television receives only the signal transmitted from the LED at the side determined to face the television.

FIG. 7 illustrates a case where the LED 704 at the left side of the remote has first received the beacon. Signal transmission from other than LED 1, i.e., from LED 2 and LED3, is stopped.

As a result, the receiver 702 of the television receives a signal representing “right” when a direction key “1” on the remote is pressed, a signal representing “down” when a direction key “2” is pressed, a signal representing “left” when a direction key “3” is pressed, and a signal representing “up” when a direction key “4” is pressed.

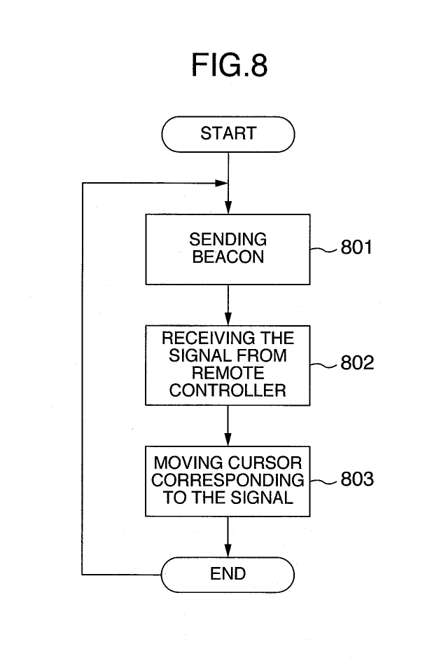

FIG. 8 shows a flow of processing performed by the television when the remote is held horizontal and at an angle with respect to the television. First, the television is transmitting the beacon signal at all times (step 801). Next, after receiving a signal from the remote (step 802), the television moves a cursor on the GUI according to the signal received (step 803). The signal received is one transmitted from the LED on the remote that is arranged by the side of the receiver which has first received the beacon.

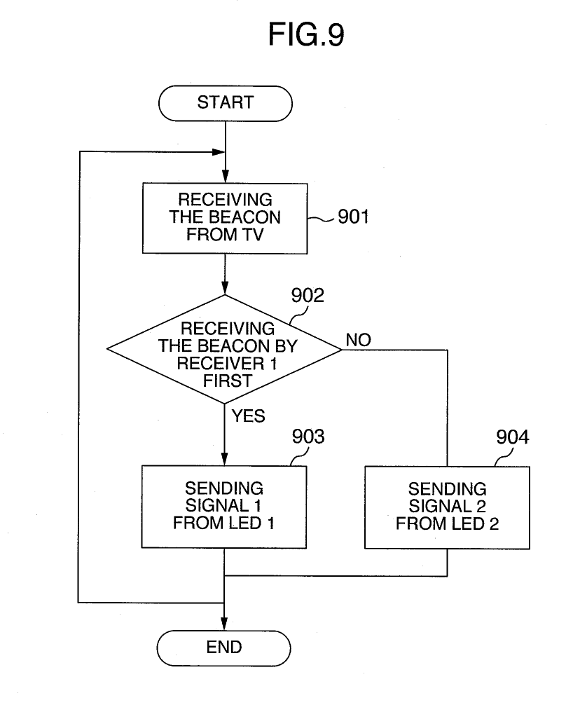

FIG. 9 shows a flow of processing performed by the remote when the remote is held horizontal and at an angle with respect to the television.

The remote receives the beacon from the television by the receivers installed at its sides (step 901). The time it takes for each beacon receiver at the sides of the remote to receive the beacon varies depending on how the remote is held.

The CPU of the remote determines at which side of the remote the associated beacon receiver has first received the beacon signal (step 902). In this example, if the remote is held tilted toward right, the CPU checks which of the upper side and the left side of the remote faces the television (step 902). A signal is then transmitted from the LED mounted at the side facing the television.

If the check finds that the upper side of the remote squarely faces the television, the LED 1 at the upper surface of the remote transmits a signal 1 (step 903). Here, the signal 1 transmitted represents “up” when the button 1 is pressed, “right” when the button 2 is pressed, “down” when the button 3 is pressed, and “left” when the button 4 is pressed.

If the check finds that the left side of the remote squarely faces the television, the LED 2 at the left side of the remote transmits a signal 2 (step 904). Here, the signal 2 transmitted represents “right” when the button 1 is pressed, “down” when the button 2 is pressed, “left” when the button 3 is pressed, and “up” when the button 4 is pressed.

If the remote is held vertical and at an angle, the tilt sensor can precisely determine which side of the remote faces up. So, the arrangement described with reference to FIG. 7, FIG. 8 and FIG. 9 need not be used.

It should be further understood by those skilled in the art that although the foregoing description has been made on embodiments of the invention, the invention is not limited thereto and various changes and modifications may be made without departing from the spirit of the invention and the scope of the appended claims.

1. A remote control device to transmit an operation signal including direction information to a target device to be operated, the remote control device comprising:
an input unit to accept an operation signal including first direction information; and
a signal transmission unit;
wherein the signal transmission unit includes a plurality of transmitters to transmit signals from sides of a body of the remote control device in different directions;
wherein the signal transmission unit transmits second direction information from the plurality of transmitters, the second direction information being generated by transforming the first direction information of the operation signal accepted by the input unit so that the second direction information matches the directions in which the plurality of transmitters perform transmission.

2. A remote control device according to claim 1, wherein the input unit has direction buttons arranged to match the first direction information to enter the first direction information;
wherein, when arrangement directions of the direction buttons used to enter the first direction information almost match directions of signal transmissions by the transmitters, the signal transmission unit transmits a signal representing “up” as the second direction information.

3. A remote control device according to claim 1, wherein the signal transmission unit transmits from the plurality of transmitters simultaneously second direction information that differs according to the signal transmission direction of each transmitter.

4. A remote control device according to claim 1, further including a plurality of beacon receivers arranged at those sides of a body of the remote control device which correspond to the signal transmission directions of the plurality of transmitters and adapted to receive a beacon from the target device to be operated;
wherein the signal transmission unit determines, based on beacon reception states in the plurality of beacon receivers, a side of the remote control device body that almost squarely faces the target device to be operated and transmits the second direction information from the transmitter in the direction of that side.

5. A remote control device to transmit an operation signal including direction information to a target device to be operated, the remote control device comprising:
an input unit to accept an operation signal including first direction information;
a tilt sensor to detect an inclination at which a body of the remote control device is held; and
a signal transmission unit;
wherein the signal transmission unit transforms the first direction information into second direction information based on the inclination detected by the tilt sensor and transmits the second direction information.

6. A remote control device according to claim 5, wherein the input unit has direction buttons arranged to match the first direction information to enter the first direction information;
wherein, when the first direction information is entered, the signal transmission unit transmits the second direction information that is generated based on the detected inclination such that an operation signal from the direction button arranged closest to a vertical direction represents “up”.

7. An operation signal input system having a target device to be operated and a remote control device to transmit an operation signal including direction information to the target device, the remote control device comprising:
an input unit to accept an operation signal including first direction information; and
a signal transmission unit;
wherein the signal transmission unit includes a plurality of transmitters that transmits signals from sides of a body of the remote control device in different directions;
wherein the signal transmission unit transmits from the plurality of transmitters second direction information which is generated by transforming the first direction information of the operation signal accepted by the input unit according to the direction of transmission performed by the plurality of transmitters;
the target device comprising:
a receiving unit to receive the second direction information transmitted from the remote control device; and
a processing unit to control the operation according to the second direction information.

8. An operation signal input system according to claim 7, wherein the signal transmission unit of the remote control device transmits the second direction information having a combination of the first direction information and ID information identifying each transmitter;
wherein the processing unit of the target device transforms the first direction information based on the ID information of the transmitters included in the second direction information and controls the operation according to the transformed first direction information.
